(19) United States
(12) Patent Application Publication
(10) Pub. No.: US 2006/0230199 A1
(43) Pub. Date: Oct. 12, 2006

(54) USB hub structure

(76) Inventor: Ta-Lung Yu, Hsichih City (TW)

Correspondence Address: BACON & THOMAS, PLLC, 625 SLATERS LANE, FOURTH FLOOR, ALEXANDRIA, VA, 22314, US

(21) Appl. No.: 11/101,590

(22) Filed: Apr. 8, 2005

(51) Int. Cl. G06F 13/38

(52) U.S. Cl. 710/62

(57) ABSTRACT

A USB hub structure comprises a main body, a plurality of downlink ports disposed directly on the main body, a uplink port connected to the main body with a cable and a downlink port extended outside of the main body and connected to the main body with another cable. Whereby, the uplink port and the downlink port extended outside of the main body can be engaged with each other and integrated at one side on which the downlink ports are disposed so that the structure is convenient to be carried and the downlink ports disposed on the main body can be protected.

### BACKGROUND OF THE INVENTION

1. Field of the Invention

The present invention relates to an USB hub structure, and more particularly to an USB hub in which a uplink port and downlink port extended outside a main body thereof can be engaged with each other and integrated at one side of the main body on which a plurality of downlink ports are disposed so as to be convenient for carrying the structure and protect the downlink ports disposed on the main body of the USB hub.

2. Description of Related Art

As the technique is being developed, a variety of computer peripherals such as printers and flash disks have been broadly used. A conventional UBS hub structure for connecting a computer mainframe with the peripherals is shown in FIG. 1.

As FIG. 1 shows, a USB hub structure 1 comprises a main body 11, a plurality of downlink ports 12 disposed on the main body 11 for connecting to computer peripheral electronic products and a uplink port attached to the main body 11 for connecting with a computer mainframe.

But, because the downlink ports 12 are disposed on the same side of the main body 11, two adjacent ports at the two sides of a port used to accept a computer peripheral electronic product with a bigger volume or a wider connector for being connected with a hub are caused to block so that other computer peripheral electronic products cannot be connect thereto. And, because the downlink ports 12 are fixedly disposed on one side of the main body 11, the disposition cannot be flexibly adjusted depending on the position and the requirement of the practically connected computer peripheral electronic product.

Furthermore, the metal oxidization is speeded up to shorten the use life of the USB hub structure owing to outdoor dust and air pollution, the malfunction of the hub is caused owing to the collection of dust or the deformation of the downlink ports 12 or/and uplink port 13 is caused to lose the function owing to the collision when the USB hub 11 is carried outside.

For improving the defects of the conventional hub mention above, the present invention is proposed.

### SUMMARY OF THE INVENTION

An USB hub structure according to the present invention comprises a main body, a plurality of downlink ports disposed directly on the main body, a uplink port connected with the main body through a cable and a downlink port extended outside of the main body and connected therewith through another cable, in which the uplink port and the downlink port extended outside of the main body are capable of being engaged with each other and integrated at the flank side of the main body.

A uplink port and a downlink port extended outside of a main body of a USB hub according to the present invention are capable of being engaged with each other and integrated at one side of the main body on which a plurality of downlink ports are disposed so as to protect the downlink ports on the side of the main body to prevent them from being influenced by dust collection or air pollution that speeds up the metal oxidization so as to shorten the use life, from causing a malfunction owing to the dust collection or being deformed to lose the function owing to the collision with outside stuff so that the hub entirety looks neat.

A cable accepting groove is disposed on the flank sides of a main body of a USB hub according to the present invention for accepting cables used for respectively connecting a uplink port and a downlink port extended outside of the main body with the main body to ensure that the uplink port and the downlink port extended outside of the main body are accurately engaged with each other and fixedly integrated without being displaced at one side of the main body on which a plurality of downlink ports are disposed. Further, because the cables for respectively connecting the uplink port and the downlink port extended outside of the main body with the main body are placed in the accepting groove, the cables can be protected from collision with outside stuff to avoid damage.

### BRIEF DESCRIPTION OF THE DRAWINGS

The present invention can be more fully understood by reference to the following description and accompanying drawings, in which:

FIG. 1 is a prospective view, showing a conventional USB hub structure;

FIG. 2 is a prospective view, showing an USB hub structure according to the present invention;

FIG. 3 is a schematic view, showing the use state of an USB hub structure according to the present invention; and

FIGS. 4 and 5 are schematic views, showing the storage state of an USB hub structure according to the present invention.

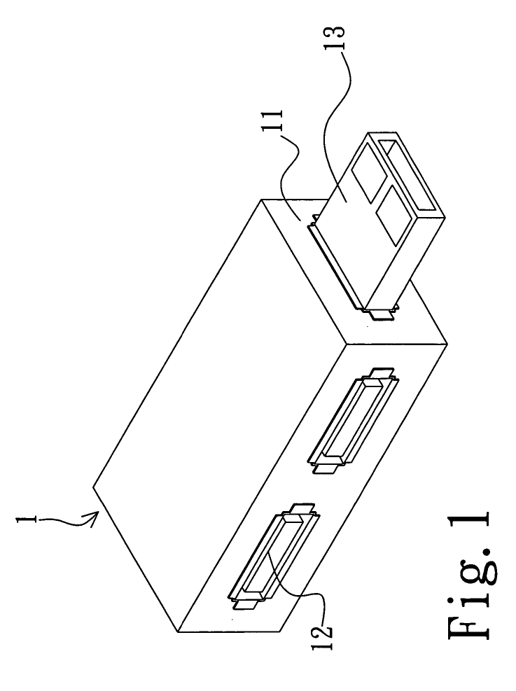

### DETAILED DESCRIPTION OF THE PREFERRED EMBODIMENTS

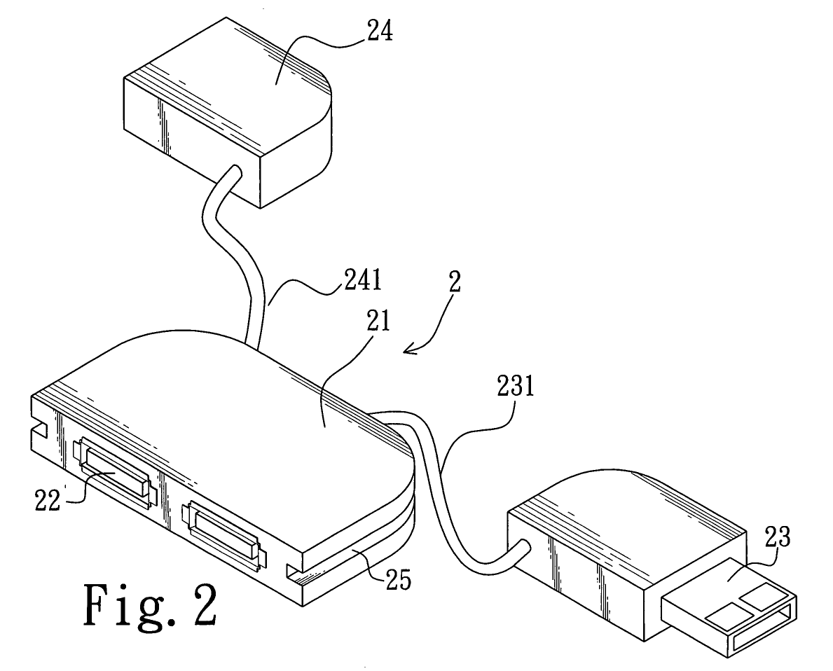

Please refer to FIG. 2. FIG. 2 is a prospective view showing a USB structure of a preferred embodiment of the present invention. A USB hub structure 2 comprises a main body 21, a plurality of downlink ports 22 disposed on the main body 21 and used for connecting computer peripheral electric equipments, a uplink port 23 used for connecting to a computer mainframe, a cable 231 for connecting the main body 21 with the uplink port 23, a downlink port extended outside of the main body 21 for connecting to a computer peripheral electric equipment, a cable 241 for connecting the main body 21 with the downlink port 24 and a cable accepting groove 25 disposed at the flank sides of the main body 21 and used for accepting the cables 231 and 241.

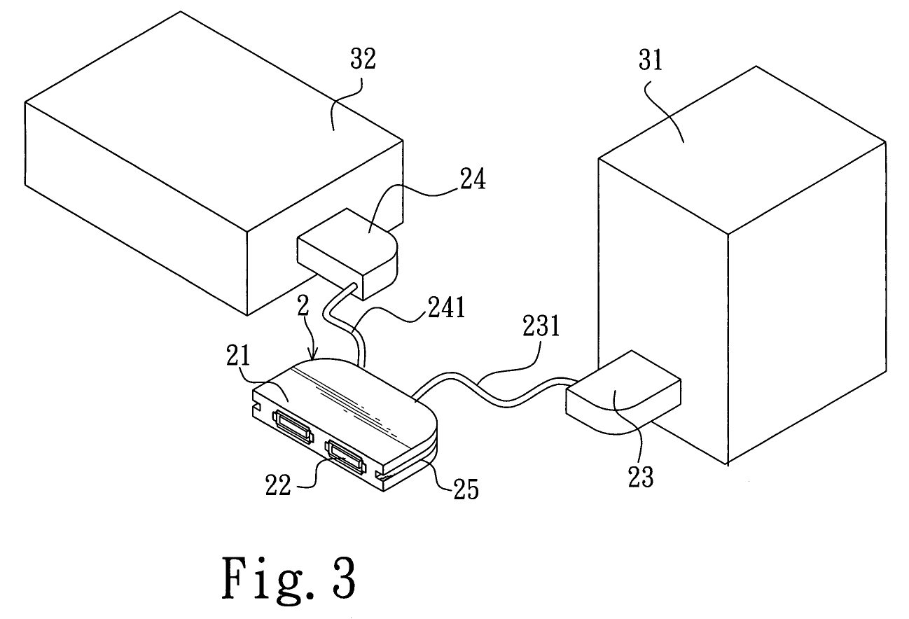

Please refer to FIG. 3. FIG. 3 is a schematic view showing a use state of a USB hub structure according to the present invention. When the USB hub structure 2 is in use, the main body 21 is connected to the uplink port 23 through the cable 231 to communicate with a computer frame 31 to process a signal transmission and the main body 21 is also connected to the downlink port 24 extended outside out of the main body 21 through the cable 241 to communicate with the computer peripheral electric equipment 32 to process a signal transmission. Because the cables 231 and 241 can be bended and deformed arbitrarily, the relative placement positions and directions of the main body 21, the computer mainframe 31 and the computer peripheral electric equipment 32 can be easier to be flexibly adjusted according to the requirement. And, when the volume of the computer peripheral electric equipment 32 is larger or a USB connecter thereof is wider, the downlink port 24 extended outside of the main body 21 can be chosen to plug in to avoid blocking the downlink ports 22.

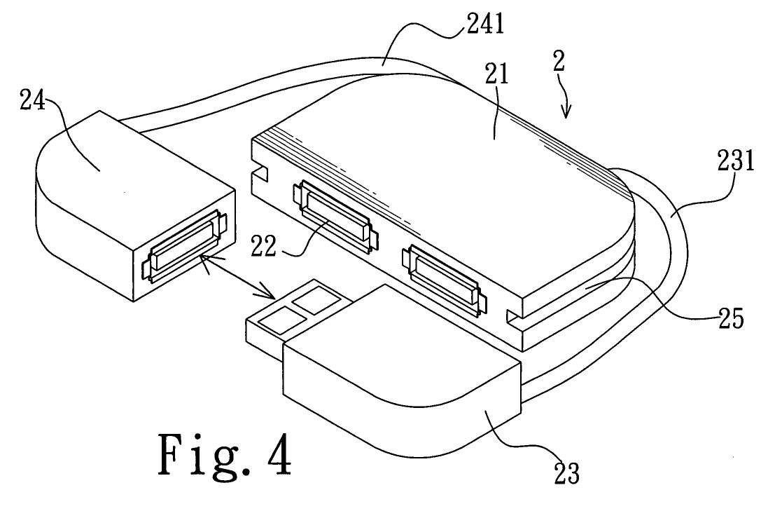

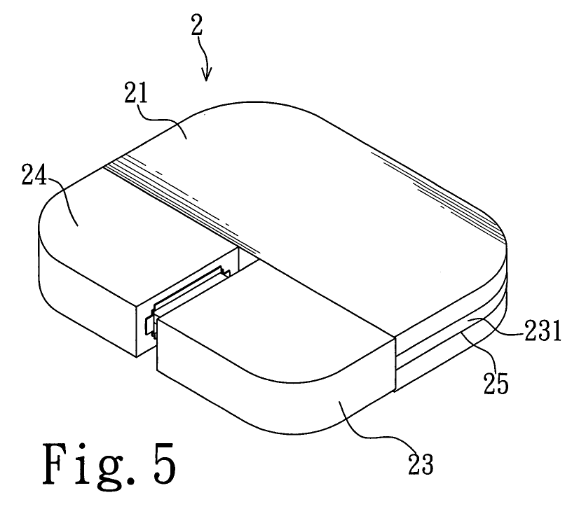

Please refer to FIGS. 4 and 5. FIGS. 4 and 5 are schematic views showing a storage state of a USB hub structure according to the present invention. When the USB hub structure 2 is about to be stored or carried, bend the cables 231 and 241 forward to cause the uplink port 23 and the downlink port 24 to be engaged with each other at the side of the main body 21 on which the downlink ports are disposed so as to cover the downlink ports to protect them from being collided or damaged by dust in the air, the entirety of the USB hub structure 2 to be more artistic and the USB hub structure 2 to be easier to be carried and stored. Furthermore, the cables 231 and 241 are juxtaposed in the cable accepting groove 25 to ensure that the uplink port 23 and the down link port 24 can be accurately engaged with each other and fixedly integrated at the side of the main body 21 on which the downlink ports 22 are disposed and not to be moved. Besides, the cables 231 and 241 can be protected from being collided and damaged so that the entirety of the USB hub structure becomes more artistic.

To sum up, according to the USB hub structure of the present invention, the main body 21, the relative placement positions and directions of the computer mainframe 31 and the computer peripheral electric equipment 32 can be flexibly adjusted according to the requirement because the cables 231 and 241 can arbitrarily be bended and deformed. And, when the volume of the computer peripheral electric equipment 32 is larger or the USB connector is wider, the connector can selectively be engaged with the downlink port 24 so as to avoid blocking the downlink port 22. Besides, the uplink port 23 and the independent downlink port 24 can be engaged with each other at the side of the main body 21 on which the downlink ports are disposed so as to cover the downlink ports 22 to protect them from being collided and damaged by dust in the air, cause the entirety of the hub structure to be more artistic and the hub structure to be easier to be stored and carried. Therefore, the USB hub according to the present invention is easy to be carried and used, and more artistic.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A USB hub structure, comprising:
a main body;
a plurality of downlink ports, disposed directly on said main body;
a uplink port, connected to said main body with a cable; and
a downlink port, extended outside of said main body and connected to said main body with another cable;
whereby, said uplink port and said downlink hub extended outside of said main body are engaged with each other and integrated at a side of said main body.

2. The UBS hub structure according to claim 1, wherein said side is a side of said main body on which said downlink ports are disposed.

3. The USB hub structure according to claim 1, wherein a cable accepting groove is disposed on the flank sides of said main body for accepting said cables.
